(19) United States
(12) Patent Application Publication
(10) Pub. No.: US 2026/0153384 A1
(43) Pub. Date: Jun. 4, 2026

(54) Digital Thermometer

(71) Applicant: SambaNova Systems, Inc., Palo Alto, CA (US)

(72) Inventors: Ha PHAM, Palo Alto, CA (US); Jinuk SHIN, San Jose, CA (US); Melissa Rae Horowitz, Sunnyvale, CA (US)

(73) Assignee: SambaNova Systems, Inc., Palo Alto, CA (US)

(21) Appl. No.: 18/967,612

(22) Filed: Dec. 3, 2024

(51) Int. Cl. G01K 7/01

(52) U.S. Cl. CPC G01K 7/01

(57) ABSTRACT

A temperature sensor system includes two P-type bipolar junction transistors (BJTs) configured as diodes and current sources operating the diodes at different current densities. The system includes a voltage reference, a multiplexer, a voltage ramp generating circuit, a comparator, an XOR circuit, a counter, and a second logic circuit (math unit). The sensor system measures temperatures by comparing the various voltages with the ramp voltage. The counter is enabled by performing an XOR function on a Start signal and the counter output or by performing an XOR function on outputs of multiple counters.

### REFERENCES

Each publication, patent, and/or patent application mentioned in this specification is herein incorporated by reference in its entirety to the same extent as if each individual publication, patent and/or patent application was specifically and individually indicated to be incorporated by reference.

### BACKGROUND

### Technical Field

The disclosed implementations relate generally to systems and methods used in temperature sensors, and in particular to those for implementation in integrated circuits (ICs). CONTEXT

Large systems-on-a-chip (SOCs) and processor ICs often require embedded temperature sensors for management of supply voltages and clock frequencies.

### BRIEF DESCRIPTION OF THE DRAWINGS

The technology will be described with reference to the drawings, in which:

FIG. 1 illustrates a first example architecture of a temperature sensor with a digital output signal.

FIG. 2 illustrates an example variation of the architecture of the temperature sensor with digital output signal.

FIGS. 3A-C give an example method for measuring the temperature using the architecture of FIGS. 1 and 2.

FIG. 4 illustrates another example architecture of a temperature sensor with a digital output signal.

FIG. 5 illustrates an example method for measuring the temperature with the architecture of FIG. 4.

FIG. 6 illustrates an example architecture for implementations with multiple sensors that may be remote.

In the figures, like reference numbers may indicate functionally similar elements. The systems and methods illustrated in the figures—and described in the Detailed Description below—may be arranged and designed in a wide variety of different implementations. Neither the figures nor the Detailed Description are intended to limit the scope as claimed. Instead, they merely represent examples of different implementations.

### DETAILED DESCRIPTION

Many integratable temperature sensors have been described over the decennia. To obtain a digital output signal from an analog element that is temperature sensitive requires some sort of analog-to-digital converter (ADC). A system-on-a-chip (SOC) or a processor IC may require knowledge of the temperature for management of supply voltages and clock frequencies. The technology described herein provides simple architectures and methods for measuring the temperature and converting the measurement result to a digital signal.

### Terminology

As used herein, the phrase “one of” should be interpreted to mean exactly one of the listed items. For example, the phrase “one of A, B, and C” should be interpreted to mean any of: only A, only B, or only C.

As used herein, the phrases at least one of and one or more of should be interpreted to mean one or more items. For example, the phrase “at least one of A, B, or C” or the phrase “one or more of A, B, or C” should be interpreted to mean any combination of A, B, and/or C. The phrase “at least one of A, B, and C” means at least one of A and at least one of B and at least one of C.

Unless otherwise specified, the use of ordinal adjectives first, second, third, etc., to describe an object, merely refers to different instances or classes of the object and does not imply any ranking or sequence.

The terms “comprising” and “consisting” have different meanings in this patent document. An apparatus, method, or product “comprising” (or “including”) certain features means that it includes those features but does not exclude the presence of other features. On the other hand, if the apparatus, method, or product “consists of” certain features, the presence of any additional features is excluded.

The term “coupled” is used in an operational sense and is not limited to a direct or an indirect coupling. “Coupled to” is generally used in the sense of directly coupled, whereas “coupled with” is generally used in the sense of directly or indirectly coupled. Coupled in an electronic system may refer to a configuration that allows a flow of information, signals, data, or physical quantities such as electrons between two elements coupled to or coupled with each other. In some cases, the flow may be unidirectional, in other cases the flow may be bidirectional or multidirectional. Coupling may be galvanic (in this context meaning that a direct electrical connection exists), capacitive, inductive, electromagnetic, optical, or through any other process allowed by physics.

The term “connected” is used to indicate a direct connection, such as electrical, optical, electromagnetic, or mechanical, between the things that are connected, without any intervening things or devices.

The term “configured” to perform a task or tasks is a broad recitation of structure generally meaning having circuitry that performs the task or tasks during operation. As such, the described item can be configured to perform the task even when the unit/circuit/component is not currently on or active. In general, the circuitry that forms the structure corresponding to configured to may include hardware circuits, and may further be controlled by switches, fuses, bond wires, metal masks, firmware, and/or software. Similarly, various items may be described as performing a task or tasks, for convenience in the description. Such descriptions should be interpreted as including the phrase configured to.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B”. This phrase specifies that B is a factor that is used to determine A or that affects the determination of A. This phrase does not foreclose that the determination of A may also be based on some other factor, such as C. This phrase is also intended to cover an implementation in which A is determined based solely on B. The phrase based on is thus synonymous with the phrase based at least in part on.

The terms “substantially”, “close”, “approximately”, “near”, and “about” refer to being within minus or plus 10% of an indicated value, unless explicitly specified otherwise.

The following terms or acronyms used herein are defined at least in part as follows:
“ADC”—analog-to-digital converter
“ASIC”—application-specific integrated circuit
“BJT”—bipolar junction transistor
“CMOS”—complementary metal-oxide-semiconductor—a transistor technology
“DEM”—dynamic element matching
“FET”—field-effect transistor
“FPGA”—field-programmable gate array
“GAAFET”—gate-all-around FET
“HBT”—heterojunction bipolar transistor
“IC”—integrated circuit—a monolithically integrated circuit, i.e., a single semiconductor die which may be delivered as a bare die or as a packaged circuit. For the purposes of this document, the term integrated circuit also includes packaged circuits that include multiple semiconductor dies, stacked dies, or multiple-die substrates. Such constructions are now common in the industry, produced by the same supply chains, and for the average user often indistinguishable from monolithic circuits.
“JFET”—junction FET
“MCM”—multi-chip module
“MESFET”—metal-semiconductor field-effect transistor
“MOS”—metal-oxide-semiconductor—a transistor technology
“NMOS transistor”—an N-type MOS transistor
“PMOS transistor”—a P-type MOS transistor
“PNP transistor”—a P-type BJT
“SOC”—system-on-a-chip
“XNOR”—exclusive NOR—a logic function
“XOR”—exclusive OR—a logic function

### Implementations

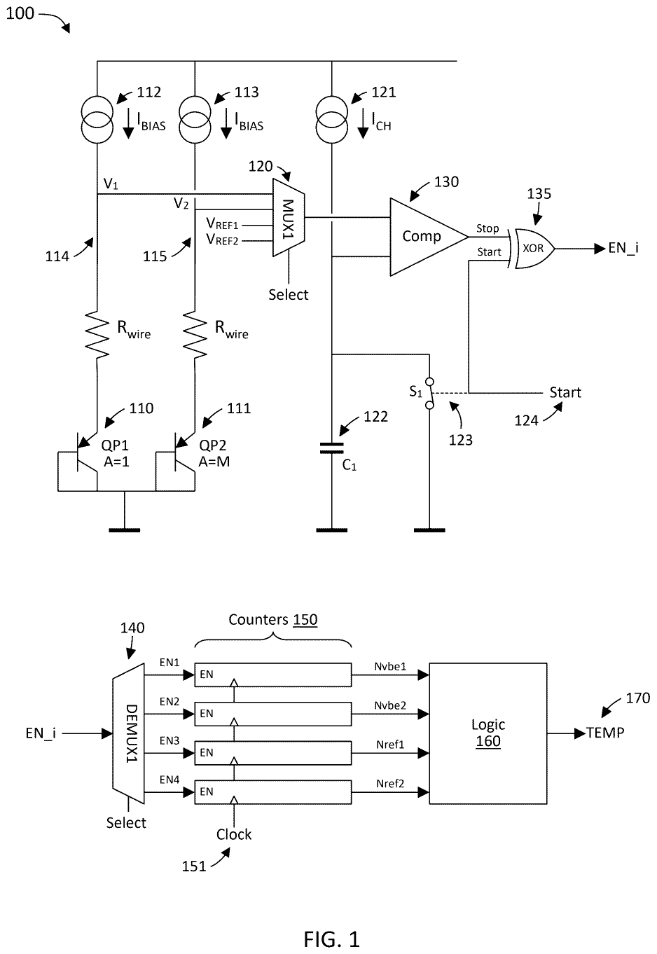

FIG. 1 illustrates a first example architecture of a temperature sensor 100 with a digital output signal 170. Temperature sensor 100 measures the absolute temperature with two P-type bipolar junction transistors (BJTs). Temperature sensors are usually made with P-type BJTs (also called PNP transistors) because they suffer less from mechanical friction as a function of changing temperature than N-type BJTs, and thus they are more thermically stable. Both the first BJT 110 and the second BJT 111 are configured as a diode. The diodes are laid out closely to each other so that they work at the same temperature, if possible without temperature gradients. Temperature sensor 100 operates the diodes at different current densities. This can be achieved by pushing different currents through identical diodes, or by pushing equal currents through diodes with different areas. In the case drawn, the currents from first current source 112 and second current source 113 are equal (I_{BIAS}), but the area of second BJT 111 is M times the area of first current source 112, for example M=2. Because the current densities in second BJT 111 is lower than in first BJT 110, its base-emitter voltage V_{BE} is lower than that of first BJT 110. Although the bias current I_{BIAS} may be small, the wire resistance of the tracks connecting first BJT 110 with first current source 112 and of second BJT 111 connecting with second current source 113 are typically not negligible. Thus, the tracks are laid out such that they have equal widths and lengths, and thus equal resistance R_{wire}. A multiplexer 120 has three or more inputs. A first input is coupled with wire 114 between first BJT 110 and first current source 112 to measure a voltage V₁, and a second input is coupled with wire 115 between second BJT 111 and second current source 113 to measure voltage V₂. A third input is coupled with a first voltage reference V_{REF1}. Although V₁ and V₂ are higher than the base-emitter voltages of first BJT 110 and second BJT 111, the difference between V₁ and V₂ equals the difference between the base-emitter voltages. This difference is:

$${V}_{BE 1} - {V}_{BE 2} = \frac{kT η}{q} ln \qquad ( 1 )$$

$$wherein :$$

$$T is the absolute temperature$$

$$k = 1.38064852 \times {10}^{- 23} ( the Boltzmann constant )$$

$$q = 1.60217662 \times {10}^{- 19} ( the charge of an electron )$$

$$η \approx 1 ( ideality factor )$$

Third current source 121 is coupled with capacitor 122, and configured to charge capacitor 122 while Start signal 124 is asserted. When Start signal 124 is not asserted, controllable switch 123 discharges capacitor 122. In some implementations, third current source 121 may be switched off when Start signal 124 is not asserted. In other implementations, the current ICH from third current source 121 may be diverted so that it doesn't flow into capacitor 122 or into controllable switch 123 when Start signal 124 is not asserted. When Start signal 124 is asserted, capacitor 122 is charged with a constant current, which generates a ramp voltage.

Comparator 130 has a first input coupled with the output of multiplexer 120 and a second input coupled with capacitor 122 so that it can compare the ramp voltage on capacitor 122 with the selected input signal of multiplexer 120 on its output. The output signal of comparator 130 is a Stop signal that enters an input of first logic circuit 135 which includes an exclusive-OR function. The second input of first logic circuit 135 is configured to receive Start signal 124.

When a temperature measurement cycle starts, capacitor 122 carries no voltage because it is short-circuited by controllable switch 123. The voltages V₁ and V₂ at wire 114 and wire 115 as well as the reference voltage V_{REF1} are all non-zero. Thus, comparator 130 compares the first selected voltage, for example V₁, with a ramp voltage of zero volts. The output of comparator 130 is not asserted, so the Stop signal is not asserted. Start signal 124 is not yet asserted either, so first logic circuit 135 has equal input signals and produces a non-asserted output signal EN_i. When the implementation asserts Start signal 124, first logic circuit 135 has different input signals and it asserts its output signal EN_i. Capacitor 122 begins charging (the ramp starts). Once the ramp voltage exceeds the first selected voltage, comparator 130 asserts the Stop signal. First logic circuit 135 now has two asserted input signals, and deasserts its output signal EN_i.

The implementation deasserts Start signal 124 so that the ramp ends and capacitor 122 is discharged. Once discharged, the implementation selects a next voltage, for example V₂, and starts the ramp again by asserting Start signal 124. In a third cycle, the implementation selects the next voltage, for example V_{REF1} and starts the ramp again by asserting Start signal 124.

Temperature sensor 100 forwards the EN_i signal to demultiplexer 140, which selects an output corresponding with the input selected on multiplexer 120. Demultiplexer 140 has three or more outputs (four are drawn) that are each coupled with the enable input of a counter 150. The counters 150 all receive a Clock signal of constant frequency. Because of demultiplexer 140, only one of the counters can be enabled and counting. Thus, when multiplexer 120 selects V₁, demultiplexer 140 selects a counter associated with V₁ and that counter keeps counting until the ramp voltage exceeds V₁, and its final value is a measure of the size of V₁ and thus of the diode voltage (base-emitter voltage) of first BJT 110. When multiplexer 120 selects V₂, demultiplexer 140 selects a counter associated with V₂, etc.

Second logic circuit 160 is coupled with each of the counters 150. Second logic circuit 160 may be dedicated logic, or a microcontroller, or an arithmetic unit. It calculates a value for output signal 170 that represents the temperature based on the counter values representing the voltages at the input of multiplexer 120. The temperature may be the absolute temperature, a Fahrenheit temperature, a Celsius temperature, or any other temperature representation. Reworking formula (1) yields:

$$T = R ( {V}_{BE 1} - {V}_{BE 2} ) \qquad ( 2 )$$

$$where$$

$$R = \frac{q}{η k ln ( M )} \qquad ( 3 )$$

The value on counter 150 depends on the measured voltage V, the current I_{CH} from third current source 121, the capacity C₁ of capacitor 122, and the frequency f of the clock:

$$N = \frac{{C}_{1} f}{{I}_{CH}} V \qquad ( 4 )$$

Assuming V_{REF1} equals 0.5 volt, the absolute temperature can be determined from:

$$T = R \frac{{V}_{2} - {V}_{1}}{1 ( volt )} = \frac{{N}_{2} - {N}_{1}}{{N}_{1 v}} = R \frac{{N}_{2} - {N}_{1}}{2 {N}_{REF 1}} \qquad ( 5 )$$

In this formula, the values of C₁, I_{CH} and f are eliminated and the value of R is a constant. The temperature in Celsius can be derived from (5) by subtracting 273.15.

Some implementations include a second voltage reference V_{REF2} coupled with a fourth input of multiplexer 120. The second voltage reference may have a higher voltage than the first voltage reference. For example, V_{REF1}=0.5 V and V_{REF2}=0.75 V. This has the advantage that a difference can be calculated that is independent of the offset voltage of comparator 130. Since second logic circuit 160 may calculate the absolute temperature T in formula (5) using a 1 V reference, it can obtain the value N_{1V} by taking four times the difference of N_{0.75V} and N_{0.5V}, related to the N values for V_{REF2} and V_{REF1}, respectively. For the difference in diode voltages of first BJT 110 and second BJT 111 the offset was already canceled. Since the reference can now also be obtained as a difference, the offset is again canceled. This means that a higher precision can be reached with relatively simple hardware. Implementations with a second voltage reference VREF2 may also have a fourth counter 150.

Another way of increasing the precision using a single reference voltage is by implementing comparator 130 as a chopper-stabilized comparator. Chopper-stabilized comparators and amplifiers are well-known in the art and many implementations are known, all of which may be used in the disclosed technology.

Yet another way of increasing the precision is by measuring the single reference voltage twice. By swapping the comparator inputs for the second measurement and inverting its output signal, the Stop signal is obtained once with regular offset and once with inverted offset. Averaging the two associated counter values will yield an N value that is unaffected by the offset.

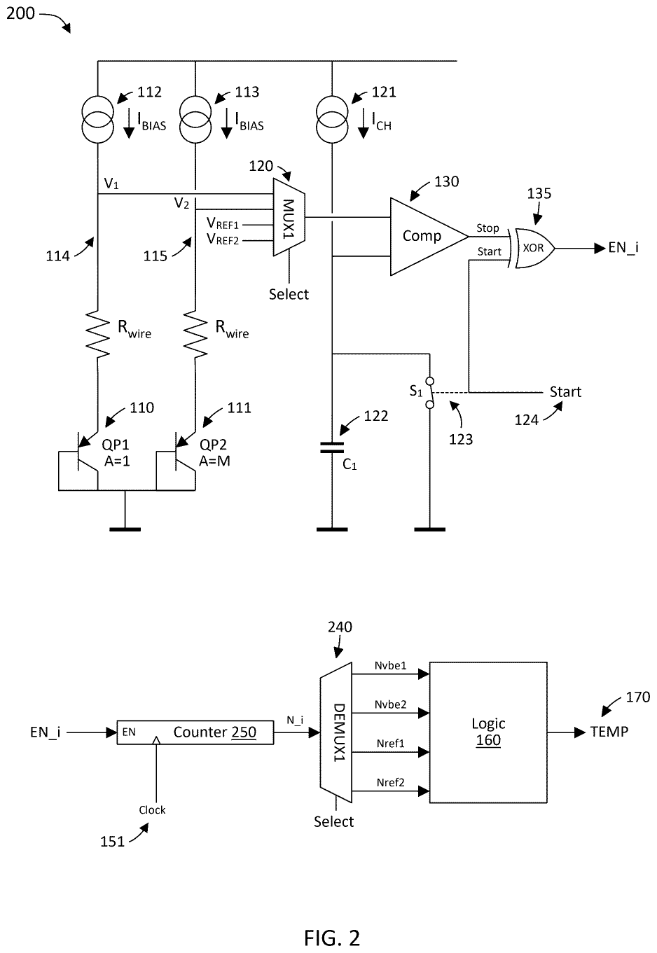

FIG. 2 illustrates an example variation of the architecture of the temperature sensor with digital output signal. Temperature sensor 200 uses most of the elements of temperature sensor 100 and with the same function. However, instead of demultiplexing the EN_i signal, it forwards the EN_i signal to a single counter 250 and demultiplexes the digital value of the counter output to the three or more inputs of second logic circuit 160 in demultiplexer 240. Demultiplexer 240 is different than demultiplexer 140. Whereas demultiplexer 140 demultiplexes a single line (a discrete-value continuous-time enable signal), demultiplexer 240 demultiplexes a discrete-value discrete-time digital number that includes multiple bits.

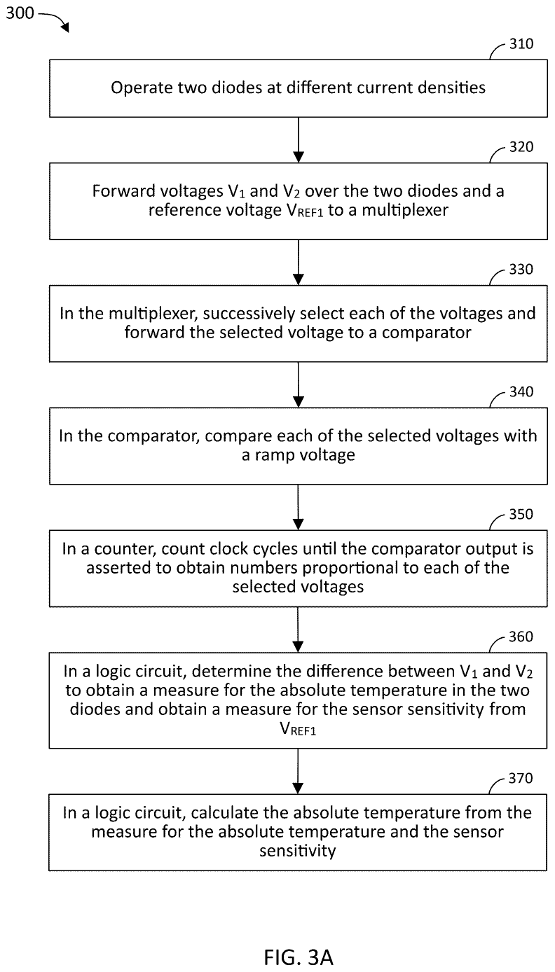

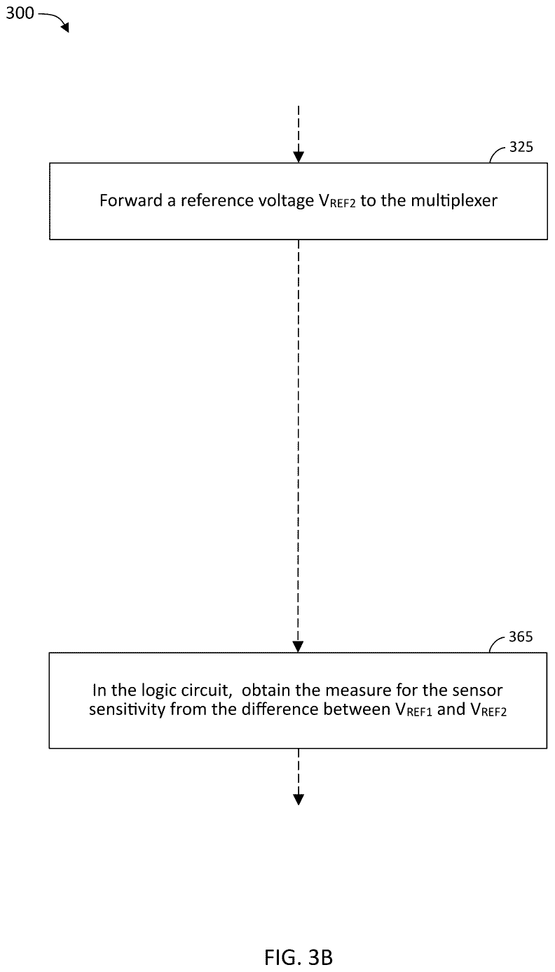

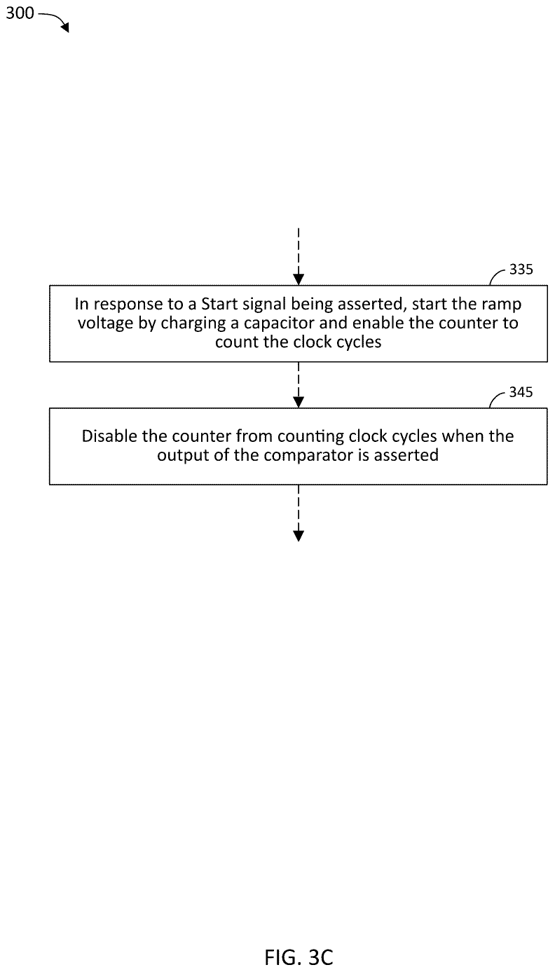

FIGS. 3A-C give an example method 300 for measuring the temperature using the architecture of FIGS. 1 and 2. Method 300 comprises:

310—operating two diodes at the temperature (that must be measured) and at two different current densities to generate a first diode voltage and a second diode voltage. Some implementations use P-type BJTs to implement the diodes. Other implementations use N-type BJTs, NMOS, or PMOS transistors to implement the diodes. Further implementations use substantially equal bias currents and the two diodes have different areas. In some cases, the two diodes have equal areas but they are operated at different bias currents. An implementation that uses BJTs may use the difference in base-emitter voltages as a measure for the absolute temperature. An implementation that uses PMOS or NMOS transistors may use the difference in gate-source voltages as a measure for the absolute temperature.

320—forwarding the first diode voltage, the second diode voltage, and a first reference voltage to a multiplexer. Some implementations forward voltages that are related to or offset from the first diode voltage and the second diode voltage. This may be the case when currents through wires between the multiplexer and the two diodes create offsets due to wire resistance. Implementations may minimize the difference between those offsets.

325—(optional, FIG. 3B) forwarding a second reference voltage to the multiplexer.

330—in the multiplexer, selecting the first diode voltage, the second diode voltage, and the first reference voltage in any order, and forwarding each of the selected voltages to a comparator.

335—(optional, FIG. 3C) in response to a Start signal being asserted, starting a ramp voltage by charging a capacitor and enabling a counter to count clock cycles.

340—in the comparator, comparing each of the selected voltages with the ramp voltage and asserting a comparator output when the ramp voltage exceeds a selected voltage.

345—(optional, FIG. 3C) disabling the counter from counting clock cycles in response to an asserted comparator output signal.

350—in the counter, counting clock cycles beginning from the Start signal and ending when the comparator output is asserted to obtain numbers proportional to each of the selected voltages.

360—in a second logic circuit, determining a difference between the first diode voltage and the second diode voltage to obtain a measure for the temperature, and determining a measure for a sensor sensitivity from the first reference voltage. The sensor sensitivity (or resolution) depends on the number of clock cycles per volt and the number of volts per degree Kelvin. The number of clock cycles per volt is determined from formula (4) and the number of volts per degree Kelvin is determined from formula (1).

$$Sensitivity = \frac{\# clocks}{Volt} \frac{Volts}{Kelvin} = \frac{N}{V} \frac{V}{T} = ( \frac{f {C}_{1}}{{I}_{CH}} ) \frac{1}{R} \qquad ( 6 )$$

Since f, C₁ and I_{CH} can all vary whereas R may be constant, it is in most cases sufficient for an implementation to determine a measure for the sensor sensitivity from the number of clock cycles per volt.

365—(optional, FIG. 3B) the second logic circuit determines the measure for the sensor sensitivity from the difference between the first reference voltage and the second reference voltage.

370—in the second logic circuit, calculating the temperature from the measure for the temperature and from the measure for the sensor sensitivity. An implementation may use the ways and mathematics described above for second logic circuit 160.

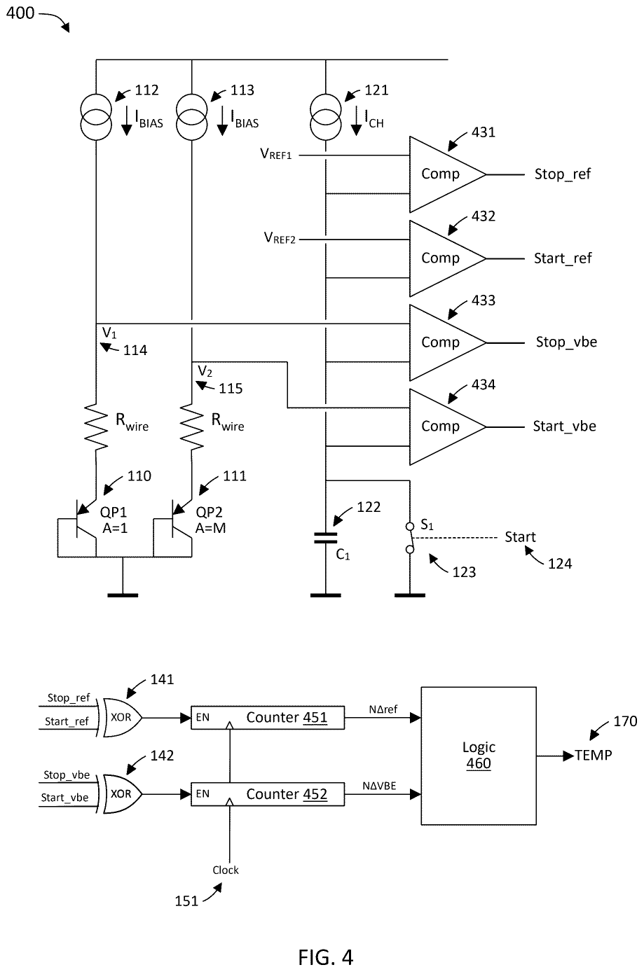

FIG. 4 illustrates another example architecture of a temperature sensor 400 with a output signal 170. To perform the core measurement, temperature sensor 400 includes first BJT 110, second BJT 111, first current source 112, second current source 113, and outputs the voltages V₁ and V₂ on wire 114 and wire 115, possibly with offsets from the base-emitter voltages of first BJT 110 and second BJT 111 caused by I_{BIAS} traveling through the two wires. Temperature sensor 400 further includes third current source 121, capacitor 122, and controllable switch 123 to generate a ramp voltage when Start signal 124 is asserted and discharge capacitor 122 when Start signal 124 is deasserted.

Temperature sensor 400 uses two voltage references and four comparators to generate counter start and counter stop signals. Comparator 431 compares the ramp voltage on capacitor 122 with first voltage reference V_{REF1} to generate the Stop_ref signal. Comparator 432 compares the ramp voltage on capacitor 122 with second voltage reference V_{REF2} to generate the Start_ref signal. Comparator 433 compares the ramp voltage on capacitor 122 with voltage V₁ to generate the Stop_vbe signal. Comparator 434 compares the ramp voltage on capacitor 122 with voltage V₂ to generate the Start_vbe signal. Note that these labels refer to enabling and disabling two counters, the reference counter 451 and the diode voltage (or V_{BE}) counter 452. The labels are based on the assumption that V_{REF1}>V_{REF2} and that V_{BE1}>V_{BE2}.

The outputs of comparator 431 and comparator 432 are coupled with the first exclusive-OR circuit 141. The outputs of comparator 433 and comparator 434 are coupled with the second exclusive-OR circuit 142. The exclusive-OR circuits are combinational logic circuits that include an XOR function. They may comprise any number and type of logic gates, but they have at least two inputs and one output, where the output is asserted when signals on the inputs are logically different and deasserted when the inputs signals are logically equal. As a result of this, when the ramp voltage is lower than both V_{REF1} and V_{REF2}, the outputs of both comparator 431 and comparator 432 are deasserted, and consequently the output of first exclusive-OR circuit 141 is deasserted as well. When the ramp voltage exceeds the lower voltage of V_{REF1} and V_{REF2}, the output of one of these two comparators is asserted and the other output is deasserted. In this case, first exclusive-OR circuit 141 has two different input signals and it asserts its output, enabling reference counter 451 to count pulses of Clock 151. When the ramp voltage exceeds the higher voltage of V_{REF1} and V_{REF2}, the outputs of both comparator 431 and comparator 432 are asserted, and consequently the output of first exclusive-OR circuit 141 is deasserted again, disabling reference counter 451. The number of clock pulses NΔref counted by reference counter 451 is proportional to the difference between V_{REF1} and V_{REF2}.

In a similar fashion, comparing the ramp voltage on capacitor 122 with V₁ and V₂ allows second exclusive-OR circuit 142 to generate the enable signal for diode voltage counter 452 and count clock pulses whose number NΔvbe is proportional to the difference between V₁ and V₂, and therefore the difference between V_{BE1} and V_{BE2}.

Second logic circuit 460 calculates the temperature based on NΔref and NΔvbe. It can do so using a variation of formula (5), which requires knowing the clock count for 1 V. A modern CMOS process may have a supply voltage lower than 1 V, so the difference between V_{REF1} and V_{REF2} will be smaller. Practical values may be V_{REF1}=0.75 V and V_{REF2}=0.5 V. With a difference of only 0.25 V, formula (5) changes to:

$$T = R \frac{{V}_{2} - {V}_{1}}{1 ( volt )} = R \frac{N Δ vbe}{4 N Δ ref} \qquad ( 7 )$$

The four comparators, comparator 431 through comparator 434, each introduce offset to the measurements, and therefore errors in the measured temperature. To increase measurement accuracy, some implementations use chopper-stabilized comparators. Other implementations measure each of the four voltages twice. By swapping each comparator's inputs for the second sets measurement and inverting the comparators' output signals, the counters receive approximately twice the number of total clock pulses. Any influence of offset voltages has been eliminated in these totals. Second logic circuit 460 can still use formula (6), since both NΔref and NΔvbe are twice as large.

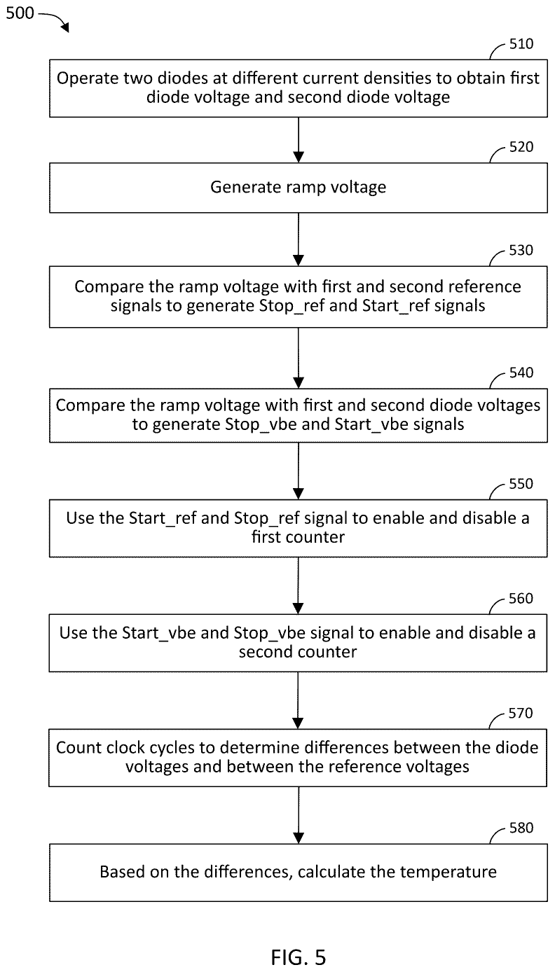

FIG. 5 illustrates an example method 500 for measuring the temperature with the architecture of FIG. 4. Method 500 comprises:
510—operating two diodes at the temperature and at two different current densities to generate a first diode voltage and a second diode voltage;
520—generating a ramp voltage by discharging a capacitor until a Start signal is received, and in response receiving the Start signal, charging the capacitor from a current source;
530—in a first comparator, comparing the ramp voltage with a first reference voltage to generate a Stop_ref signal and in a second comparator, comparing the ramp voltage with a second reference voltage to generate a Start_ref signal.
540—in a third comparator, comparing the ramp voltage with the first diode voltage to generate a Stop_vbe signal and in a fourth comparator, comparing the ramp voltage with the second diode voltage to generate a Start_vbe signal.
550—in a first exclusive-OR circuit, using the Start_ref signal and the Stop_ref signal to generate a first counter enable signal to enable and disable a first counter.
560—in a second exclusive-OR circuit using the Start_vbe signal and the Stop_vbe signal to generate a second counter enable signal to enable and disable a second counter.
570—in the first counter, counting clock cycles while the first counter enable signal is asserted to obtain a measure NΔref for a difference between the first reference voltage and the second reference voltage, and in the second counter, counting clock cycles while the second counter enable signal is asserted to obtain a measure NΔvbe for a difference between the first diode voltage and the second diode voltage.
580—based on NΔref and NΔvbe, calculating the temperature.

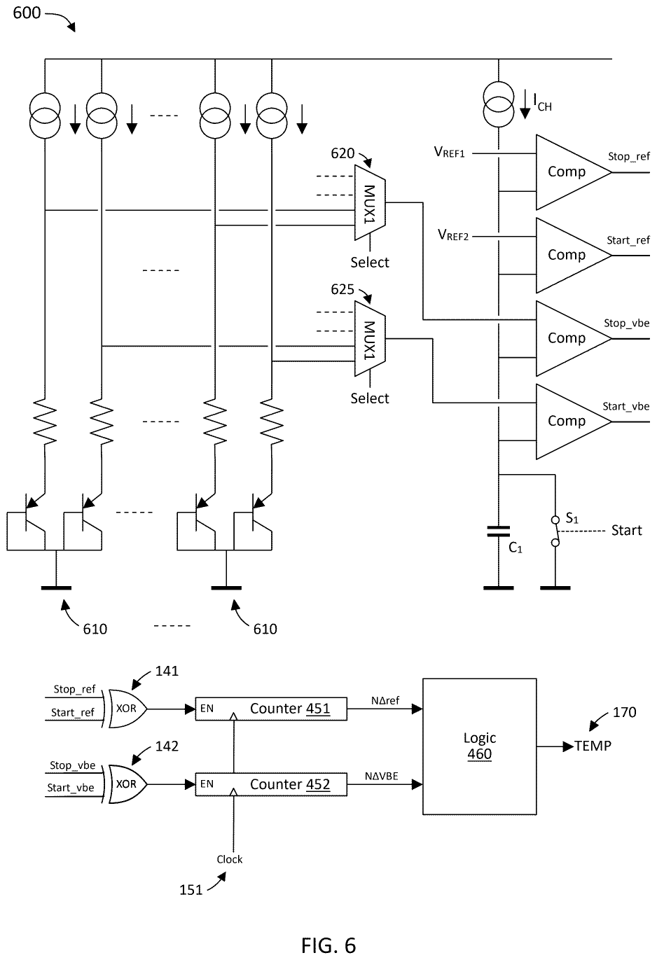

FIG. 6 illustrates an example architecture 600 for implementations with multiple sensors that may be remote. Compared with temperature sensor 400 of FIG. 4, architecture 600 has multiple sensors 610, a first multiplexer 620, and a second multiplexer 625. The two multiplexers each have (at least) as many inputs as the number of sensors 610. First multiplexer 620 connects its inputs with first outputs of sensors 610 and second multiplexer 625 connects its inputs with second outputs of sensors 610. The multiplexer outputs are coupled with the comparators that generate the Start_vbe and the Stop_vbe signals. By selecting one of the sensors 610 at a time, an implementation provides time sharing for its ADC that includes C1, ICH, S1, the four comparators, the two XOR gates, the two counters, and counters, and second logic circuit 460.

In some implementations, the comparators may be chopper stabilized, or they may swap their inputs and invert their output in second measurements to eliminate offset voltages. Similarly, the sensors 610 may implement dynamic element matching to improve their precision.

### Considerations

Although the description has been described with respect to specific implementations thereof, these specific implementations are merely illustrative, and not restrictive. The description may reference specific structural implementations and methods and does not intend to limit the technology to the specifically disclosed implementations and methods. The technology may be practiced using other features, elements, methods and implementations. Implementations are described to illustrate the present technology, not to limit its scope, which is defined by the claims. Those of ordinary skill in the art recognize a variety of equivalent variations on the description above. For example, the figures all show core temperature measuring using two P-type BJTs. However, each of those implementations may use N-type BJTs, NMOS or CMOS transistors, junction diodes, or any other pair of devices that may create a temperature-dependent voltage difference when operated at different current densities. And although all examples show equal bias currents traversing temperature sense elements of different areas, implementations may use differently size bias currents traversing equal area devices. Although all examples show the ramp voltage being generated on a capacitor, implementations my generate a ramp current using an inductor. Although in all examples the signals are implemented as voltages, other implementations may implement part or all of the signals as currents. Although the figures show implementations with XOR gates, implementations may use XNOR gates or any combinational logic circuits that include an exclusive OR function. Although the figures show first current source 112 and second current source 113 as independent current sources, implementations may use current mirrors that derive separate bias currents from a single source. Further implementations may improve matching between the two current sources by using dynamic element matching (DEM) such as described by Gerard Meijer et al., “Smart Sensor Systems, Emerging Technologies and Applications,” pages 1-8, John Wiley & Sons, 2014.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

Any suitable technology for manufacturing electronic devices can be used to implement the circuits of specific implementations, including CMOS, FinFET, GAAFET, BiCMOS, bipolar, JFET, MOS, NMOS, PMOS, HBT, MESFET, etc. Different semiconductor materials can be employed, such as silicon, germanium, SiGe, GaAs, InP, GaN, SiC, graphene, etc. Circuits may have single-ended or differential inputs, and single-ended or differential outputs. Terminals to circuits may function as inputs, outputs, both, or be in a high-impedance state, or they may function to receive supply power, a ground reference, a reference voltage, a reference current, or other. Although the physical processing of signals may be presented in a specific order, this order may be changed in different specific implementations. In some specific implementations, multiple elements, devices, or circuits shown as sequential in this specification can be operating in parallel.

It will also be appreciated that one or more of the elements depicted in the drawings/figures can also be implemented in a more separated or integrated manner, or even removed or rendered as inoperable in certain cases, as is useful in accordance with a particular application.

Thus, while specific implementations have been described herein, latitudes of modification, various changes, and substitutions are intended in the foregoing disclosures, and it will be appreciated that in some instances some features of specific implementations will be employed without a corresponding use of other features without departing from the scope and spirit as set forth. Therefore, many modifications may be made to adapt a particular situation or material to the essential scope and spirit.

1. A temperature sensor, comprising:
a first P-type bipolar junction transistor (BJT) configured as a first diode;
a second P-type BJT configured as a second diode;
a first current source coupled with the first diode and configured to operate the first diode at a first current density;
a second current source coupled with the second diode and configured to operate the second diode at a second current density different than the first current density;
a first voltage reference;
a multiplexer with a first multiplexer input coupled with the first diode and the first current source, with a second multiplexer input coupled with the second diode and the second current source, with a third multiplexer input coupled with the first voltage reference, and with a multiplexer output;
a third current source;
a capacitor coupled with the third current source;
a controllable switch with a switch control input and two terminals coupled in parallel with the capacitor, wherein the switch control input is configured to receive a Start signal;
a comparator with a first comparator input coupled with the multiplexer output and a second comparator input with the third current source and the capacitor;
a first logic circuit with a first input coupled with a comparator output, a second input configured to receive the Start signal, and with a first logic circuit output, wherein the first logic circuit includes an exclusive-OR function;
a first counter configured to be enabled by the first logic circuit and clocked by a Clock signal; and
a second logic circuit coupled with the first counter and configured to calculate an output temperature based on counter values representing a first diode voltage, a second diode voltage, and a voltage of the first voltage reference.

2. The temperature sensor of claim 1, further comprising:
a demultiplexer with a demultiplexer input coupled with the first logic circuit output and a first demultiplexer output coupled with the first counter;
a second counter with an input coupled with a second demultiplexer output and an output coupled with the second logic circuit; and
a third counter with an input coupled with a third demultiplexer output and an output coupled with the second logic circuit.

3. The temperature sensor of claim 1, further comprising:
a second voltage reference coupled with a fourth multiplexer input; and
a fourth counter with an input coupled with a fourth demultiplexer output and an output coupled with the second logic circuit.

4. The temperature sensor of claim 1, wherein the comparator is a chopper-stabilized comparator.

5. The temperature sensor of claim 1, further comprising:
a demultiplexer with a demultiplexer input coupled with a first counter output and three or more outputs coupled with the second logic circuit.

6. A method of measuring a temperature, comprising:
operating two diodes at the temperature and at two different current densities to generate a first diode voltage and a second diode voltage;
forwarding the first diode voltage, the second diode voltage, and a first reference voltage to a multiplexer;
in the multiplexer, selecting the first diode voltage, the second diode voltage, and the first reference voltage in any order, and forwarding each of the selected voltages to a comparator;
in the comparator, comparing each of the selected voltages with a ramp voltage;
in a counter, counting clock cycles beginning from a Start signal and ending when an output of the comparator is asserted to obtain numbers proportional to each of the selected voltages;
in a second logic circuit, determining a difference between the first diode voltage and the second diode voltage to obtain a measure for the temperature, and determining a measure for a sensor sensitivity from the first reference voltage; and
in the second logic circuit, calculating the temperature from the measure for the temperature and from the measure for the sensor sensitivity.

7. The method of claim 6, further comprising forwarding a second reference voltage to the multiplexer, and wherein:
determining the measure for the sensor sensitivity from the first reference voltage includes determining a difference between the first reference voltage and the second reference voltage.

8. The method of claim 6, wherein the ramp voltage is obtained from charging a capacitor by a current source.

9. A temperature sensor comprising:
a first P-type bipolar junction transistor (BJT) configured as a first diode;
a second P-type BJT configured as a second diode;
a first current source coupled with the first diode and configured to operate the first diode at a first current density;
a second current source coupled with the second diode and configured to operate the second diode at a second current density different than the first current density;
a first voltage reference providing a first reference voltage;
a second voltage reference providing a second reference voltage;
a third current source;
a capacitor coupled with the third current source;
a controllable switch with a switch control input and two terminals coupled in parallel with the capacitor, wherein the switch control input is configured to receive a Start signal;
a first comparator with a first input coupled with the first reference voltage and a second input coupled with the third current source and the capacitor;
a second comparator with a first input coupled with the second reference voltage and a second input coupled with the third current source and the capacitor;
a third comparator with a first input coupled with the first diode and a second input coupled with the third current source and the capacitor;
a fourth comparator with a first input coupled with the second diode and a second input coupled with the third current source and the capacitor;
a first exclusive-OR circuit with a first input coupled with an output of the first comparator and a second input coupled with an output of the second comparator;
a second exclusive-OR circuit with a first input coupled with an output of the third comparator and a second input coupled with an output of the fourth comparator;
a first counter with an enable input coupled with an output of the first exclusive-OR circuit;
a second counter with an enable input coupled with an output of the second exclusive-OR circuit; and
a second logic circuit coupled with the first counter and with the second counter and configured to calculate an output temperature based on counter values representing a difference between a first diode voltage and a second diode voltage and representing a difference between the first reference voltage and the second reference voltage.

10. The temperature sensor of claim 9, wherein the first comparator, second comparator, third comparator, and fourth comparator are chopper stabilized.

11. A method of measuring a temperature, comprising:
operating two diodes at the temperature and at two different current densities to generate a first diode voltage and a second diode voltage;
generating a ramp voltage by discharging a capacitor until a Start signal is received, and in response receiving the Start signal, charging the capacitor from a current source;
in a first comparator, comparing the ramp voltage with a first reference voltage to generate a Stop_ref signal;
in a second comparator, comparing the ramp voltage with a second reference voltage to generate a Start_ref signal;
in a third comparator, comparing the ramp voltage with the first diode voltage to generate a Stop_vbe signal;
in a fourth comparator, comparing the ramp voltage with the second diode voltage to generate a Start_vbe signal;
in a first exclusive-OR circuit, using the Start_ref signal and the Stop_ref signal to generate a first counter enable signal;
in a second exclusive-OR circuit using the Start_vbe signal and the Stop_vbe signal to generate a second counter enable signal;
in a first counter, counting clock cycles while the first counter enable signal is asserted to obtain a measure NΔref for a difference between the first reference voltage and the second reference voltage;
in a second counter, counting clock cycles while the second counter enable signal is asserted to obtain a measure NΔvbe for a difference between the first diode voltage and the second diode voltage; and
based on NΔref and NΔvbe, calculating the temperature.

12. The method of claim 11, further comprising swapping input signals of the first comparator and swapping input signals of the second comparator.

13. The method of claim 11, further comprising swapping input signals of the third comparator and swapping input signals of the fourth comparator.

14. The method of claim 11, wherein any of the first comparator, second comparator, third comparator, and/or fourth comparator is chopper stabilized.
